(19) United States
(12) Patent Application Publication
(10) Pub. No.: US 2014/0244518 A1
(43) Pub. Date: Aug. 28, 2014

(54) AMBIENT CONDITIONS MONITORING SYSTEM FOR MACHINERY

(71) Applicant: SOLAR TURBINES INCORPORATED, San Diego, CA (US)

(72) Inventors: Edward Charles Fichtner, San Diego, CA (US); Chae Hyon Kil, Chula Vista, CA (US); Garrett Linn Schiff, San Diego, CA (US); Andrew Alexander Baldwin, San Diego, CA (US)

(73) Assignee: Solar Turbines Incorporated, San Diego, CA (US)

(21) Appl. No.: 13/776,954

(22) Filed: Feb. 26, 2013

(51) Int. Cl. G01N 35/00; G01W 1/00; G06Q 10/00; G06F 17/00

(52) U.S. Cl. CPC G01N 35/00; G06F 17/00; G01W 1/00; G06Q 10/20
USPC 705/305; 702/182; 702/3

(57) ABSTRACT

A method for monitoring machines is provided. According to the method, a computer server determines a location of at least one machine. The complier server transmits a request to an external source for ambient conditions associated with the location of the at least one machine. The computer server receives a response indicative of the ambient conditions associated with the location of the at least one machine. In addition, the computer server evaluates operation of the at least one machine based in part on the received ambient conditions.

### TECHNICAL FIELD

The present disclosure is directed to a system for monitoring ambient conditions for machinery.

### BACKGROUND

Operation and performance of a gas turbine engine may depend on a variety of ambient conditions, such as atmospheric pressure, air temperature, humidity, etc. The ambient conditions may be affected by a wide range of parameters, such as local weather conditions, precipitation, climate changes, storms, or the like. Sudden and/or long-term changes can occur in the performance and operation of a gas turbine engine system. Availability of information about ambient conditions can assist to examine these changes more accurately and to determine the health of the gas turbine engine system at a particular time or over an extended period of time.

U.S. Patent Application Publication No. 20120072194A1 discloses as method for modeling turbine operation to identify operating characteristics of the turbine based on performance parameters and external factors. The external factors include ambient conditions, such as temperature, barometric pressure, humidity, and the like. These external factors may be measured or sensed, may be estimated or otherwise provided manually by an operator, or may be provided by third party information sources (e.g., weather services., etc.).

In conventional gas turbine systems, day-to-day operation does not require measurements of ambient conditions. Thus, conventional gas turbine engine systems may not collect or use the information about ambient conditions for monitoring changes in the performance. Sensors in conventional gas turbine engine systems may not provide the information about the ambient conditions that is useful for short-term and long-term performance analysis and monitoring.

### SUMMARY

According to one embodiment of the disclosure, a method tot monitoring machines is provided. According to the method a computer server determines a location of at least one machine. The computer server transmits a request to an external source for ambient conditions associated with the location of the at least one machine. The computer server receives a response indicative of the ambient conditions associated with the location of the at least one machine. In addition, the computer server evaluates operation of the at least one machine based in part on the received ambient conditions.

According to another embodiment, a system for monitoring machines is provided. The system comprises a fleet of machines disposed at different locations and a data logging device configured to collect operational data from the fleet of machines. The system further comprises a server configured to receive the operational data from the data logging device on a periodic basis. The server is further configured to determine a location of at least one of the machines. The server is further configured to transmit a request to an external source for ambient conditions associated with the location of the at least one of the machines. The server is further configured to receive a response indicative of the ambient conditions associated with the location of the at least one of the machines. The server is further configured to evaluate operation of the at least one of the machines based on the operational data and the received ambient conditions.

### BRIEF DESCRIPTION OF THE DRAWINGS

FIG. 1 is a diagram of an exemplary disclosed monitoring system for monitoring, ambient conditions for machinery; and

FIG. 2 is a flow chart illustrating an exemplary process for monitoring ambient conditions for machinery.

### DETAILED DESCRIPTION

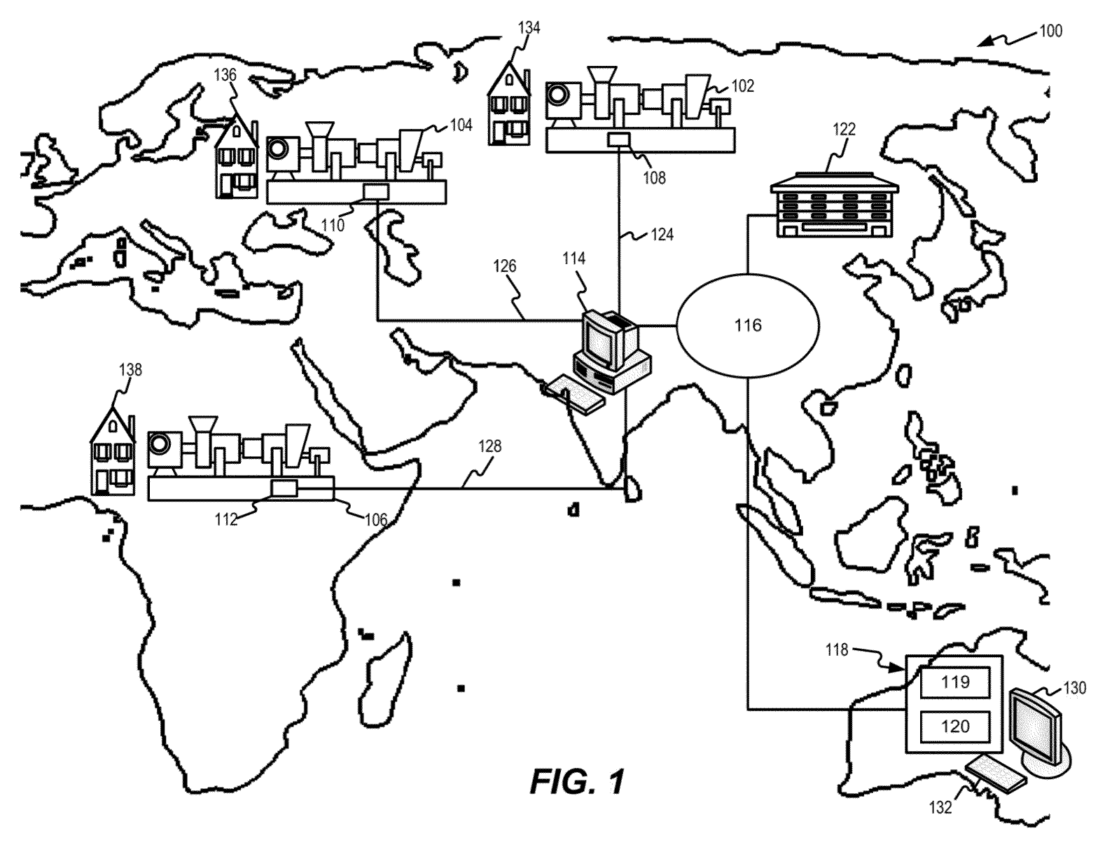

FIG. 1 illustrates a diagram of an exemplary disclosed system 100 for collecting and monitoring ambient conditions for machinery in particular, system 100 includes a plurality of machines 102, 104, and 106 to be monitored, a data logging device 114, a remote monitoring server 118, and a weather service provider 122.

Machines 102-106 ID may be any mechanical systems, mechanical-electrical systems, or industrial systems. According to one embodiment, systems 102-106 may be operated in one or more predetermined geographical areas. For example, systems 102-106 may include machines and equipment, moving around one or more mining sites or construction sites. According to another embodiment, systems 102-106 may be stationary and located at one or more locations and operated by one or more operators. As shown in FIG. 1, systems 102-106 may be distributed at any locations in a predetermined area, such as the U.S. or around the world. Systems 102-106 may also be relocated, occasionally or regularly, from one location to another location as desired.

According to one embodiment, systems 102-106 may be configured to provide power to various driven equipment. For example, systems 102-106 may include gas turbine engine systems configured to drive gas compressors, electric generators, an conditioning systems, power mills, or other equipment known in the art. According to a further embodiment, the driven equipment, such as the gas compressors, may be integrated with systems 102-106, which may be provided to customers as integrated systems.

Systems 102-106 include on-board control units 108, 110, and 112 configured to control, monitor, and diagnose performance and operation of associated systems 102-106. For example, control units 108-112 may each include a processor, a computer-readable medium, and peripheral circuits. The computer-readable medium includes instructions, which may be executed by the processor, to collect performance and operational data of associated systems 102-106. Control units 108-112 may, for example, collect performance and operational data indicative of a rotational speed and a power output of a shaft, an operational temperature of a given component, a pressure of a particular location within individual system 102-106 or other parameters known in the art. Based on the performance and operational data, control units 108-112 may control operation of systems 102-106 or diagnose operational problems or malfunctions thereof.

Additionally, control units 108-112 may each include a local clock for determining a local time at the location of the associated system. Control units 108-112 may use their local clocks to set the schedule to periodically collect the performance and operational data. The performance and operational data collected by control units 108-112 indicates the status and operational state of systems 102-106 at individual time instances.

Operation and performance of systems 102-106 may depend on ambient conditions at individual sites or locations. The ambient conditions that affect the operation and performance of systems 102-106 may include, for example, atmospheric temperature, air pressure, air humidity, oxygen concentration, fain fall, wind speed, or other ambient conditions known in the art. The ambient conditions may affect long-term performance and operational health of systems 102-106. Thus, the performance of systems 102-106 may vary over an extended period of time, such as days, weeks, months, and years, according to the fluctuation of the ambient conditions.

Systems 102-106 may not have the ability to detect the ambient conditions. As a result, control units 108-112 may only monitor operation of systems 102-106 at a particular time instance or over a short period of time. Control units 108-112 may not detect long-term variations of the performance and operational health of systems 102-106 caused by changes in the ambient conditions.

Control units 108-112 may communicate with data logging device 114 through communication links 124, 126, and 128. Communication links 124-128 may be wired or wireless communication links within an industrial communication network configured to transmit data between control units 108-112 and data logging device 114 according to a known protocol. Data logging device 114 may he located at the same location as one or more of systems 102-106. For example, data logging device 114 may be disposed in a control room near systems 102-106 in a power generator plant or a manufacturing center. According to some embodiments, data logging device 114 may be located remotely from systems 102-106.

Data logging device 114 may be a computer including a network interface configured to communicate with control units 108-112. Data logging device 114 may further include a processor and a computer-readable medium such as a computer memory, a hard drive a flash drive, or other storage devices known in the art. The computer-readable medium may store instructions, which are executed by the processor and cause the processor to receive and process the data from control units 108-112. Data logging device 114 may further include a display device for display of the data from control units 108-112 to an operator.

More specifically, data logging device 114 may receive the performance and operational data of systems 102-106 from respective control units 108-112 and store the data in a database within the computer-readable medium. Data logging device 114 may further receive time information generated by the local docks of control units 108-112 and store the time information in relation to the performance and operational data he time information may identify the local tunes at which the performance and operational data are collected.

According to some embodiments, data logging device 114 may periodically pull the data from control units 108-112 at a predetermined time interval or according to a preset schedule. Alternatively, data logging device 114 may pull the data from control units 108-112 on demand or at a request of the operator. Still alternatively, control units 108-112 may automatically post the data to data logging device 114 periodically or on demand.

Additionally or alternatively, system 100 may include a plurality of data logging devices 114. The plurality of data logging devices 114 may be located at different geographical locations and configured to receive, process, and store data from control units 108-112 of the systems. Alternatively, each data logging device 114 may receive, process, and store data from systems located at multiple geographical locations.

Additionally, data logging device 114 may be configured to communicate with remote server 118 through a computer network 116, Computer network 116 may be one or more of an Internet, a Local Area Network (LAN), a Wide Area Network (WAN), a wireless network, or other networks known in the art, Data logging device 114 may transmit the data collected from control units 108-112 of systems 102-106 to server 118 through computer network 116. The data may include, for example, identifications of systems 102-106, performance and operational data, and time information indicative of the local times of systems 102-106. Data logging device 114 may transmit the data to Server 118 in batch or in separate data packets. Data logging device 114 may push the data to server 118 periodically or at the request of the operator. Alternatively, server 118 may pull data from data logging device 114 periodically or at the request of the operator.

The data may be transmitted from data logging device 114 to server 118 on a periodic basis. For example, server 118 may receive or sample the data from data logging device 114 once every second, every minute, every hour, every day, or every multiple days. Data logging device 114 may form a data batch including data collected over the period and transmit the data batch to server 118. Alternatively, the data batch may include data collected, at a particular time from a machine.

Server 118 includes a processor 119 and a non-transitory computer-readable medium 120. Computer-readable medium 120 may be a computer memory, a hard drive, or other information storage device known in the art. Server 118 may receive the data from data logging device 114 and store the data in computer-readable medium 120. Computer-readable medium 120 may further store information about the sites or locations of systems 102-106. For example, the sites or locations el individual systems 102-106 may be identified by their respective longitudes, latitudes, and/or altitudes stored within computer-readable medium 120. Computer-readable medium 120 further store computer-executable instructions, which may be executed by processor 119 to process the data received from data logging device 114. The computer-executable instructions may be written in a programming language known in the art.

Server 118 may be coupled to a display device 130 and a user input device 132. Display device 130 may generate a user interface to present the data and processing results to a user or an operator of server 118. The data and the processing results presented by display device 130 may include both real-time and historical data associated with systems 102-106. User input device 132 may include a mouse, a keyboard, a touch pad, etc., and be configured to receive user input. Display device 130 and user input, device 132 in combination allow the user to interact with server 118, as desired.

Server 118 may further communicate with a weather service provider 122, through network 116 or other networks, for receiving information about the ambient conditions related to the location(s) of systems 102-106. Server 118 may store the information about the ambient conditions corresponding to systems 102-106. Server 118 may provide long-term monitoring and evaluation of the performance of systems 102-106 based, in part, on the ambient conditions received from weather service provider 122.

Weather service provider 122 may he any commercial or non-commercial entity that records ambient conditions within a particular region or around the world and provides information about the ambient conditions at a given location upon request. Weather service provider 122 may include a plurality of weather stations 134, 136, and 138, which are configured to collect data about the ambient conditions at a plurality of locations. Weather stations 134, 136, and 138 may be proximate to the locations of systems 102-106, respectively. According to a further embodiment, each one of weather stations 134, 136, and 118 may include a plurality of weather stations distributed within a geographical area, in which the respective machine is located.

Weather service provider 122 may further include a weather database for storing the information about the ambient conditions at a plurality of locations. The weather database may be located at a location remotely from those of systems 102-106 The information about the ambient conditions may include, for example, air temperature, atmospheric pressure, wind, speed and direction, rain fall, humidity, or other weather-related information known in the art. The information about the ambient conditions stored in the weather database for each location may be updated periodically to include newly-collected ambient conditions. The weather database may store the information about the ambient conditions over an extended period of time, such as months or years. In addition, the weather database may also store the local time at which the information about the ambient conditions is collected. The weather database may associate the local time with the corresponding information about the ambient conditions.

According to a further embodiment, the weather database may identify each location by its location information. The location information may include, for example, one or more of a longitude, a latitude, an altitude, a zip code, an address, or other information that may be used to identify a location.

According to a further embodiment, server 118 may send a request to weather service provider 122 for information about ambient conditions associated with systems 102-106. The request may identify a location of a machine by its location information. The request may further include a user credential and a network address that uniquely identifies server 118. The request may additionally indicate a time or a time period, during which the ambient conditions are desired.

Upon receiving the request from server 118, weather service provider 122 may look up the information about the ambient conditions in the weather database using the location and the time information in the request. Weather service provider 122 may return the requested information about the ambient conditions to server 118.

If the requested location or time is not found in the weather database, weather service provider 122 may determine an estimate of the ambient conditions at the requested location based on the ambient conditions stored in the weather database for nearby locations or times. For example, weather service provider 122 may use a triangulation method or an interpolation technique known in the art to estimate the ambient conditions at the requested location or time based on the ambient conditions at a plurality of locations or times proximate to the requested location or time. Other estimation techniques known in the art may also be used by weather service provider 122.

Alternatively, weather service provider 122 may return the information about the ambient conditions at the nearby locations or times to server 118. Server 118 may then estimate the ambient conditions at a location of the machine or a given time based on those at the nearby locations or times received from weather service provider 122.

Still alternatively, weather service provider 122 may provide the information about the ambient conditions at the nearby locations or times to a thud party, which estimates the ambient conditions at the requested location or time based on those at the nearby locations or times. The third party may then provide the estimate to server 118.

After determining. the information about the ambient conditions, server 118 may associate the information with systems 102-106 based on their individual identifications and locations and store the information in computer-readable medium 120. Server 118 may store the information about the ambient conditions for systems 102-106 over an extended period of time, such as months, years, or an entire service lifetime. Server 118 may further conduct performance analysis systems 102-106 over the period of time using the information about the ambient conditions. For example, server 118 may analyze variations of the performance of systems 102-106, such as output power, operational temperatures, downtime, etc., in relation to the ambient conditions. Server 118 may further compare the performance of a selected one of systems 102-106 at different times. Based on the comparison, server 118 may evaluate the effects of fluctuations in the ambient conditions on performance of the machine.

In addition, server 118 may provide the analysis results to a user and generate warning messages if abnormalities of systems 102-106 are detected. Server 118 may provide the warning messages to a fleet manager, who is responsible for managing systems 102-106. The warning messages may then prompt the fleet manager to further analyze the abnormalities or to contact the operator of systems 102-106 to investigate any causes of the abnormalities. Thus, server 118 provides long-term performance management and monitoring for systems 102-106 based in part on the ambient conditions received from weather service provider 122.

### INDUSTRIAL APPLICABILITY

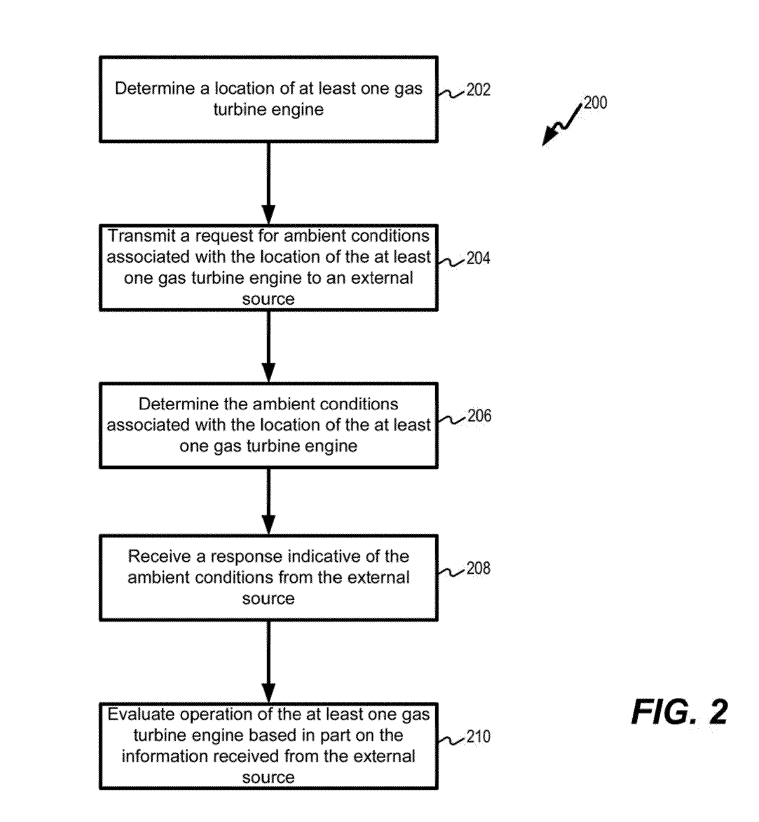

FIG. 2 illustrates a flow chart of an exemplary process 200 for monitoring ambient conditions for a fleet of has turbine engines utilizing system 100 of FIG. 1 According to process 200, at step 202, a location of at least one of the turbine engines is determined. For example, server 118 may determine the location based on an identification of the turbine engine. Server 118 may search an internal database stored in computer-readable medium 120 based on the identification. The search result may provide server 1118 with the longitude, latitude, and/or altitude corresponding to the location of the turbine engine. Server 118 may also use other techniques known in the art for determining and identifying the location of the turbine engine being monitored.

At step 204, server 118 transmits a request for information about ambient conditions associated with the location of the turbine engine. Server 118 may transmit the request to an external source, such as weather service provider 122. The request may include the identification of the turbine engine system, the location information associated with the location of the turbine engine system, and the time (including date and time) at which the ambient conditions are desired.

The request may further include a network identification or address of server 118 and credential or authentication information of server 118. The request may be provided in a known data formation, such as the HTML format, the XML format, or other formats known in the art. The request may be routed through network 116 or other networks and received by the external source.

Server 118 may transmit the request on a periodic basis, such as every minute, every hour, every day, etc. Server 118 may request from the external source the information about the ambient conditions collected at a particular time or over a particular period of time.

At step 206, system 100 determines the ambient conditions associated with the location of the turbine engine at the requested time. For example, upon receiving the request, the external source may then authenticate the request based on the credential information. The external source may then search in a weather database for the requested ambient conditions. Based on the search results, the external source may determine or estimate the ambient conditions at the requested location at the requested time. For example, the external source may search for the requested ambient conditions in the weather database according to the location and time carried in the request.

If the requested location or time is not found in the weather database, the external source may determine an estimate of the ambient conditions at the requested location or time based on the ambient conditions stored in the weather data for nearby locations or times. For example, the external source may use a triangulation method or an interpolation technique known in the art to estimate the ambient conditions at the requested location or time based on the ambient conditions at a plurality of locations or times proximate to the requested location or time. Other estimation techniques known in the art may also be used.

In estimating the ambient conditions at the requested location based on the ambient conditions at the nearby locations, system 100 may consider the differences between the requested location and the nearby locations. For example, system 100 may calculate the elevation differences between the requested location and the nearby locations anti modify the information about the ambient conditions at the nearby location according to the elevation differences.

Alternatively or additionally, system 100 may select one or more of the nearby locations according to the location information to estimate the ambient conditions at the requested location. For example, system 100 may select only the nearby locations that have substantially similar longitudes or latitudes as that of the requested location, if locations with similar longitudes or latitudes generally have similar ambient conditions.

Still alternatively, system 100 may estimate the ambient conditions at the requested location in view of the time differences between the nearby locations and the requested location. :For example, in an area where weather patterns generally move from west to east, system 100 may estimate the ambient conditions at the requested location based on a delayed version or an advanced version of the ambient conditions at the nearby locations, depending on whether the nearby locations are located to the east or west of the requested location and the time differences between them. Other methods for estimating the ambient conditions at the requested location as known in the art may also be used by system 100.

After determining the requested ambient conditions, the external source may return a response to server 118 including information about the ambient conditions. The response may have a data format similar to that of the request from server 118 and may include the information about the requested ambient conditions. The external source may transmit the response on a periodic basis in the future without additional requests from server 118.

Alternatively, the external source may provide the information about the ambient conditions at the nearby locations or times to a third party, which estimates the ambient conditions at the requested location or time based on those at the nearby locations or times. The third party may then provide the estimate to server 118 in a response.

At step 208, server 118 receives the response from the external source or the third party and parses the information carried therein. Server 118 may extract the information about the ambient conditions from the response and store the information in computer-readable medium 120. Server 118 may associate a turbine engine with the information about the ambient conditions based on the identification of the turbine engine. Server 118 may store the information about the ambient conditions collected over an extended period of time, such as weeks, months, or years, and store the information for each individual turbine engine.

At step 210, server 118 evaluates the operation of each individual turbine engine based, in put, on the information received from the external source. For example, server 118 may compare the performance and operational data of a particular turbine engine system collected at different times. Server 118 may determine the differences in ambient conditions at the different times. Server 118 may then present the differences in ambient conditions at the different times along with the performance and operational data. A user of server 118 may then consider the variants of the performance and operational data in light of the differences in the ambient conditions. Server 118 may use the ambient conditions to normalize the performance and operational data and provide the normalized performance and operational data to assist with the performance analysis.

According to an alternative embodiment, step 206 may be performed by server 118 after receiving the response from the external source at step 208. For example, the external source may return the information about the ambient conditions at the nearby locations or times to server 118. Server 118 may then estimate the ambient conditions at a location of the turbine engine system for a given time based on those at the nearby locations or times received from the external source.

Since ambient conditions may affect the performance of machines, taking them into account, when evaluating the performance, may remove or normalize the effects of the ambient conditions on the performance and operational data collected from the control units. It may allow better understanding of the performance and operational data and their changes over time or at a given instance. In addition, some ambient conditions may result in sudden changes in the performance of the machines. For example, rain storms or dust storms may generate particles, which may be ingested into a gas turbine, thereby altering the performance of the system. Incorporating the information about the ambient conditions may thus provide a more complete context to analyzing the performance of the system.

The above-disclosed ambient condition monitoring system and method, while being described for use in connection with gas turbine engine systems, can be used generally in alternative applications and environments. For example, the above-disclosed monitoring system may be used in any mechanical, electrical, or industrial systems that require monitoring of local ambient conditions for performance analysis and long-term health management. In addition, the information about the ambient conditions may be used to modify control logic in as control unit (e.g., control units 108-112) associated with a machine. The control unit may control the operation of the machine based on the normalized performance and operational data.

Systems 102-106 being monitored, such as the gas turbine engine systems discussed above or machines moving around a local sites, may be distributed in a large geographical area or may be installed at locations difficult to access by field personnel. As a result, it may be economically prohibitive to install on-board sensors, while the systems remain in service, to collect the information about the local ambient conditions. System 100 may thus be used to collect and monitor the information about the ambient conditions at the locations of gas turbine engine systems 102-106 without the need to install the on-board sensors.

Additionally; when a machine is relocated from one location to another location, system 100 may maintain a history of the relocation and a history of the ambient conditions associated with all previous and current locations of the machine. Thus, system 100 may maintain historical data of the ambient conditions at the previous locations after the machine is relocated. System 100 may store the historical data in, for example, server 118 and may retrieve the historical data at a request of a user. The historical data allows the user to monitor and analyze the performance of the machine in view of the relocation and the variations of the ambient conditions from one location to another location.

Additionally, the communications between server 118 and weather service provider 122. are independent from the communications between server 118 and logging device 114. Thus, system 100 may provide a reliable data collection means to monitor the ambient conditions experienced by systems 102-106, even when the communications between server 118 and logging device 114 are interrupted due to hazardous or extreme weather conditions.

Still additionally, server 118 may also be integrated, in a business decision system to provide data to assist with service and maintenance of systems 102-106. For example, server 118 may be maintained by a manufacturer for collecting long-term performance data and ambient conditions of the turbine systems purchased or leased by customers. The manufacturer may determine a customized service contract or warranty contract for a particular turbine engine system based on the information about the ambient conditions provided by server 118. The manufacturer may negotiate pricing and terms of the service contract with a customer based on the performance data and ambient conditions collected over the lifetime of a turbine engine. The manufacturer may also document the ambient conditions along with the performance data and provide the documentation to the customer as part of the warranty services. The manufacturer may manage the maintenance activities based on the results of the performance evaluations when taking into account the ambient conditions.

It will be apparent to those skilled in the art that various modifications and variations can be made to the disclosed system. Others embodiments will be apparent to those skilled in the art from consideration of the specification and practice of the disclosed system. it is intended that the specification and examples be considered as exemplary only with a true scope being indicated by the following claims and their equivalents.

What is claimed is:

1. A method for monitoring machines, comprising:
determining, by a computer server, a location of at least one machine;
transmitting, by the computer server, a request to an external source for ambient conditions associated with the location of the at least one machine;
receiving, by the computer server, a response indicative of the ambient conditions associated with the location of the at least one machine; and
evaluating, by the computer server, operation of the at least one machine based in part on the received ambient conditions.

2. The method of claim 1, further comprising transmitting the request to the external source on a periodic basis.

3. The method of claim , further comprising:
receiving from a data logging device operational data associated with the at least one machine; and
evaluating the operation of the at least one machine further includes evaluating the operational data.

4. The method of claim 3, further comprising:
comparing the operational data collected at different times and under different ambient conditions.

5. The method of claim I, wherein the request identifies the location by location information including at least one of a longitude, a latitude, an altitude, a zip code, or an address.

6. The method of claim 5, further comprising:
determining the longitude, the latitude, and the altitude of the location based on an identification of the at least one machine.

7. The method of claim 1, further comprising:
requesting the ambient conditions associated with the location of the at least one machine over a period of time defined by a user.

8. The method of claim 7, further comprising:
providing a long-term health management service to the at least one machine based on the ambient conditions.

9. The method of claim 1, wherein the at least one machine includes a fleet of machines provided in a plurality of different locations, and the ambient conditions for each of the plurality of locations are requested, received, and evaluated.

10. The method of claim 9, further comprising:
identifying the machines within the fleet by the respective identification.

11. The method of claim 9, thither comprising:
customizing a service contract for each of the machines within the fleet based in part on the ambient conditions associated with the respective machines.

12. The method of claim 1, wherein the external source includes a weather service provider, and the request has a format recognizable by the weather service provider, the request further including authentication information and network identification information of the computer server.

13. The method of claim 1, further comprising determining the ambient conditions by searching a database according to the location of the at least one machine.

14. The method of claim 13, further comprising estimating the ambient conditions associated with the location based on ambient conditions at nearby locations.

15. A system for monitoring machines, comprising:
a fleet of machines;
a data logging device configured to collect operational data from the fleet of machines; and
a server configured to:
receive the operational data from the data logging device on a periodic basis;
determine a location of at least one of the machines;
transmit a request to an external source for ambient conditions associated with the location of the at least one of the machines;
receive a response indicative of the ambient conditions associated with the location of the at least one of the machines; and
evaluate operation of the at least one of the machines based on the operational data and the ambient conditions.

16. The system of claim 15, wherein, when the at least one of the machines is relocated from a previous location to a current location, the server stores a history of relocation of the machine and a history of the ambient conditions of the previous location and the current location.

17. The system of claim 15, wherein the external source includes a weather service provider located remotely from the machines.

18. The system of claim 15, wherein the machines are disposed at different locations and reside in predetermined geographical areas.

19. The system of claim 18, wherein the machines are stationary and configured to provide power to driven equipment.

20. The system of claim 19, wherein, the machines include at least one gas turbine engine system.
